(19) United States
(12) Patent Application Publication
(10) Pub. No.: US 2015/0051078 A1
(43) Pub. Date: Feb. 19, 2015

(54) Glyphosate tank mix adjuvant comprising a base selected from a carbonate and/or a phosphate

(71) Applicant: BASF SE, Ludwigshafen (DE)

(72) Inventors: Gerhard Schnabel, Elsenfeld (DE); Marc Nolte, Mannheim (DE); Gerhard Genari, Limburgerhof (DE); Paul Klingelhoefer, Mannheim (DE); Mariano Ignacio Etcheverry, Mannheim (DE); Steven Bowe, Apex, NC (US); John Frihauf, Raleigh, NC (US); Chad Brommer, Raleigh, NC (US); Terrance M. Cannan, Raleigh, NC (US); Walter Thomas, Fuquay-Varina, NC (US); Maarten Staal, Durham, NC (US)

(21) Appl. No.: 14/385,669

(22) PCT Filed: Mar. 19, 2013
(86) PCT No.: PCT/EP2013/055673

§ 371 Date: Sep. 16, 2014

Related U.S. Application Data
(60) Provisional application No. 61/613,505, filed on Mar. 21, 2012.
(60) Provisional application No. 61/662,385, filed on Jun. 21, 2012.
(60) Provisional application No. 61/669,681, filed on Jul. 10, 2012.

(30) Foreign Application Priority Data
Mar. 28, 2012 (EP) 12161847.4

(51) Int. Cl. A01N 57/20; A01N 25/02

(52) U.S. Cl. CPC A01N 57/20; A01N 25/02
USPC 504/206; 504/362

(57) ABSTRACT

The present invention relates to a method for preparing a tank mix, which comprises the step of contacting a glyphosate formulation, water, and a tank mix adjuvant, wherein the tank mix adjuvant comprises a base selected from a carbonate or an alkali salt of a phosphate, and wherein the tank mix adjuvant is present in form of an aqueous liquid, which contains at least 50 g/l of the base, or in form of a particulate solid, which contains at least 10 wt % of the base, wherein the tank mix has a tank mix acidity of at least pH 8.0, and wherein the tankmix contains at least 50 wt % water. The invention also relates to a method of controlling phytopathogenic fungi and/or undesired vegetation and/or undesired insect or mite attack and/or for regulating the growth of plants, wherein the tank mix is allowed to act on the respective pests, their environment or the plants to be protected from the respective pest, on the soil and/or on undesired plants and/or the crop plants and/or their environment.

The present invention relates to a method for preparing a tank mix, which comprises the step of contacting a glyphosate formulation, water, and a tank mix adjuvant, wherein the tank mix adjuvant comprises a base selected from a carbonate and/or a phosphate, and wherein the tank mix adjuvant is present in form of an aqueous liquid, which contains at least 50 g/l of the base, or in form of a particulate solid, which contains at least 10 wt % of the base. The present invention also relates to a tank mix adjuvant which comprises the auxiliary and the base selected from a carbonate and/or a phosphate, wherein the tank mix adjuvant is present in form of an aqueous liquid, which contains at least 50 g/l of the base, and wherein the auxiliary is a humectant The invention also relates to a method of controlling phytopathogenic fungi and/or undesired vegetation and/or undesired insect or mite attack and/or for regulating the growth of plants, wherein the tank mix is allowed to act on the respective pests, their environment or the plants to be protected from the respective pest, on the soil and/or on undesired plants and/or the crop plants and/or their environment. The preferred embodiments of the invention mentioned herein below have to be understood as being preferred either independently from each other or in combination with one another.

It is generally known that the uptake and biological efficacy of pesticides may be improved by adjuvants. It is still a goal to develop better adjuvants.

Penner and Michael, Journal of ASTM, 2010, 7 (6), 129-136 analyzed the spray solution pH between 1.5 and 6 and glyphosate activity. They concluded that “there was no effect of spray solution pH on glyphosate-IPA activity on any of the three weed species” which they have tested.

Shea and Tupy, Weed Science, 1984, 32, 802-806 analyzed the reversal of cation-induced reduction in glyphosate activity with EDTA. Glyphosate activity was greater at pH 4 than at pH 6 or 10. Their studies supported “previous research indication that . . . glyphosate activity increases as pH decreases”.

Buhler and Burnside, Weed Science 1983, 31, 163-169 analyzed the effect of water quality, carrier volume, and acid on glyphosate phytotoxicity.

Climb® Marketing Minute 2009 by Wilsbur-Ellis discloses carbonic acid dipotassium salt in an alkalinity agent.

US 2010/0016160 discloses a herbicidal composition comprising orthosulfamuron, a further herbicide and optionally an inorganic or organic base.

WO 2001/78512 discloses a method for protecting a plant from phytotoxic injury from application to a locus thereof of glyphosate, which method comprises applying glyphosate and a safening amount of a salt.

The object was solved by a method for preparing a tank mix, which comprises the step of contacting a glyphosate formulation, water, and a tank mix adjuvant, wherein the tank mix adjuvant comprises a base selected from a carbonate and/or a phosphate, and wherein the tank mix adjuvant is present in form of an aqueous liquid, which contains at least 50 g/l of the base, or in form of a particulate solid, which contains at least 10 wt % of the base.

In another form the object was solved by a method for preparing a tank mix, which comprises the step of contacting a glyphosate formulation, water, and a tank mix adjuvant, wherein the tank mix adjuvant comprises a base selected from a carbonate or an alkali salt of a phosphate, and wherein the tank mix adjuvant is present in form of an aqueous liquid, which contains at least 50 g/l of the base, or in form of a particulate solid, which contains at least 10 wt % of the base, wherein the tank mix has a tank mix acidity of at least pH 8.0, and wherein the tankmix contains at least 50 wt % water.

The contacting of the glyphosate formulation, water, and the tank mix adjuvant may be achieved by mixing the components in any sequence. The contacting may take place in a tank, in which the tank mix is prepared, by pouring the glyphosate formulation, water, and the tank mix adjuvant into the tank, optionally followed by stirring. Preferably, the contacting is done at ambient temperature, such as from 5 to 45° C.

The weight ratio of glyphosate formulation to water is usually in a range of from 1:1 to 1:10000, more preferably from 1:5 to 5000, and in particular from 1:10 to 1:1000.

The tank mix is usually an aqueous liquid, which is ready to be applied (e.g. by spraying) in the method of controlling phytopathogenic fungi and/or undesired vegetation and/or undesired insect or mite attack and/or for regulating the growth of plants.

Typically, the tank mix contains at least 50 wt % water, preferably at least 65 wt %, more preferably at least 80 wt % and in particular at least 90 wt %.

The water is preferably untreated natural water, such as ground water, rain water collected in a water reservoir, river water, or lake water. For comparison, treated water relates to tap water, which has passed a sewage plant.

The water may be soft, medium or hard water. Preferably it is medium or hard water. Usually, the water has a hardness of at least 5° dH, preferably at least 10° dH, more preferably at least 15° dH, and in particular at least 20° dH (German degrees of hardness). In another form the water contains at least 0.1 mmol/l, preferably at least 1.0 mmol/l, more preferably at least 2.0 mmol/l, even more preferably at least 3.0 mmol/l, and in particular at least 3.5 mmol/l of the sum of calcium ions and magnesium ions.

The tank mix which may have a tank mix acidity of at least pH 5.0. Preferably, the tank mix acidity corresponds to a pH of at least 6.0, better of at least 7.0, more preferably of at least 7.5, especially preferred of at least 8.0 and in particular of at least 8.5. The tank mix acidity may correspond to a pH of up to 13.0, preferably of up to 11.0 and in particular of up to 9.0. The tank mix acidity is usually determined as pH value at 20° C. without dilution of the tank mix.

Typically, the base is selected from a carbonate, a phosphate, or a mixture thereof. Preferably, the base is selected from an alkali salt of a carbonate, an alkali salt of hydrogencarbonate, or mixtures thereof. Alkali salts refer to salts containing preferably sodium and/or potassium as cations. The carbonate and the phosphate may be present in any crystal modification, in pure form, as technical quality, or as hydrates (e.g. K₂CO₃×1.5 H₂O).

Suitable carbonates are alkali or earth alkaline salts of CO₃²⁻ or of HCO₃⁻ (hydrocarbonates). Preferred carbonates are alkali salts of CO₃²⁻ or of HCO₃⁻. Especially preferred carbonates are selected from sodium carbonate, sodium hydrogencarbonate, potassium carbonate, potassium hydrogencarbonate, and mixtures thereof.

Mixtures of carbonates are also possible. Preferred mixtures of carbonates comprise alkali salts of CO₃²⁻ and alkali salts of HCO₃⁻. Especially preferred mixtures of carbonates comprise potassium carbonate and potassium hydrogencarbonate; or sodium carbonate and sodium hydrogencarbonate. The weight ratio of alkali salts of CO₃²⁻ (e.g. K₂CO₃) to alkali salts of HCO₃⁻ (e.g. KHCO₃) may be in the range of 1:20 to 20:1, preferably 1:10 to 10:1. In another form, the weight ratio of alkali salts of CO₃²⁻ (e.g. K₂CO₃) to alkali salts of HCO₃⁻ (e.g. KHCO₃) may be in the range of 1:1 to 1:25, preferably of 1:2 to 1:18, and in particular of 1:4 to 1:14.

Suitable phosphates are alkaline or earth alkaline salts of secondary or tertiary phosphates, pyrrophosphates, and oligophosphates. Alkali salts of phosphates are preferred, such as Na₃PO₄, Na₂HPO₄, and NaH₂PO₄, and mixtures thereof.

The tank mix may comprise further bases, such as an organic amine and/or an inorganic base, which is different from the base. In another form the further bases may comprise the carbonate in case the base comprises the phosphate (e.g. the base is selected from an alkali salt of phosphate and the further base is a carbonate). In another form the further bases may comprise the alkalisalt of phosphate in case the base comprises the carbonate (e.g. the base is selected from a carbonate and the further base is an alkali salt of phosphate). In a preferred form the tank mix comprises up to 40 mol %, preferably up to 15 mol %, and in particular up to 3 mol % further bases, based on the total amount of the base selected from a carbonate and/or a phosphate. In another form the tank mix is essentially free of further bases.

Examples for inorganic bases are a hydroxide, a silicate, a borate, an oxide, or mixtures thereof. In a preferred form the inorganic base comprises a hydroxide.

Suitable hydroxides are alkaline, earth alkaline, or organic salts of hydroxides. Preferred hydroxides are NaOH, KOH and choline hydroxide, wherein KOH and choline hydroxide are preferred.

Suitable silicates are alkaline or earth alkaline silicates, such as potassium silicates.

Suitable borates are alkaline or earth alkaline borates, such as potassium, sodium or calcium borates. Fertilizers containing borates are also suitable.

Suitable oxides are alkaline or earth alkaline oxides, such as calcium oxide or magnesium oxide. In a preferred form oxides are used together with chelating bases.

The base and the further base may be present in dispersed or dissolved form in the tank mix, wherein the dissolved form is preferred.

The base and the further base have preferably has a solubility in water of at least 1 g/l at 20° C., more preferably of at least 10 g/l, and in particular at least 100 g/l.

Usually, the amount of the base depends on the desired pH value in the tank mix (i.e. the tank mix acidity). First, the desired pH may be selected and then the required amount of base is added while controlling the pH value of the tank mix.

The tank mix may contain from 0.4 to 200 g/l, preferably from 0.8 to 100 g/l, and in particular from 2 to 50 g/l of the base.

The molar ratio of the base to the pesticide may be from 30:1 to 1:10, preferably from 10:1 to 1:5, and in particular from 5:1 to 1:1. For calculation of the molar ratio, the sum of all bases (e.g. CO₃²⁻ and HCO₃⁻) except the further base may be applied. For calculation of the molar ratio, the sum of all pesticides (preferably of all anionic pesticides) may be applied.

Typically, the tank mix adjuvant is essentially free of pesticides. This means, that the adjuvant usually contains less than 1 wt %, preferably less than 0.2 wt %, and in particular less than 0.05 wt % of a pesticide.

In one form the tank mix adjuvant is present in form of an aqueous liquid (e.g. at 20° C.), which contains at least 200 g/l, preferably at least 300 g/l, and in particular at least 400 g/l of the base. In another form the tank mix adjuvant is present in form of an aqueous liquid (e.g. at 20° C.), which contains at least 100 g/l, preferably at least 150 g/l of the base. In another form the tank mix adjuvant may contain up to 600 g/l, preferably up to 500 g/l of the base. The aqueous liquid may contain at least 5 wt %, preferably at least 15 wt %, and in particular at least 30 wt % water. The aqueous liquid may contain up to 80 wt %, preferably up to 65 wt %, and in particular up to 50 wt % water.

The aqueous liquid may have a pH value of at least 8.0, preferably at least 8.5, more preferably at least 9.0, even more preferably at least 9.5, in particular at least 10.0, even more particular at least 11.0. The aqueous liquid may have a pH value of up to 14.0, preferably up to 13.0, and in particular up to 12.0. The aqueous liquid may have a pH value in the range of 8.0 to 14.0, preferably of 8.0 to 13.0, and in particular form 8.5 to 12.5.

The aqueous liquid may comprise auxiliaries, such as those listed below. Preferably, the aqueous liquid comprises auxiliaries such as anti-freezing agents (e.g. glycerin), anti-foaming agents, (e.g. silicones), anti-drift agents, crystallization inhibitors (e.g. salts of polyacrylic acid) or binders. The aqueous liquid may comprise up to 15 wt %, preferably up to 10 wt %, and in particular up to 5 wt % auxiliaries.

In a preferred form the aqueous liquid contains at least 200 g/l of the base (such as an alkali salt of CO₃²⁻ and/or an alkali salt of HCO₃⁻), up to 15 wt % of auxiliaries (e.g. anti-drift agent and crystallization inhibitors (e.g. salts of polyacrylic acid)), and has a pH value of at least 8.0.

In a preferred form the aqueous liquid contains at least 250 g/l of the base (such as an alkali salt of CO₃²⁻ and/or an alkali salt of HCO₃⁻), up to 10 wt % of auxiliaries (e.g. anti-drift agent and crystallization inhibitors (e.g. salts of polyacrylic acid)), and has a pH value of at least 8.5.

In another form the tank mix adjuvant is present in form of a particulate solid (e.g. at 20° C.), which contains at least 50 wt %, preferably at least 80 wt %, and in particular at least 90 wt % of the base. In another form the tank mix adjuvant is present in form of a particulate solid (e.g. at 20° C.), which contains at least 20 wt %, preferably at least 30 wt %, and in particular at least 40 wt % of the base. In another form the tank mix adjuvant may contain up to 99 wt %, preferably up to 95 wt, and in particular up to 90 wt % of the base.

The particulate solid may have a particle size D₉₀ of up to 100 mm, preferably up to 10 mm, and in particular up to 5 mm. The particle size may be determined by sieving.

The particulate solid may contain less than 1 wt % dust. Dust means typically particles, which have a particle size of below 50 μm.

The particulate solid may be soluble in water (e.g. in the tank mix) in an amount of at least 0.5 wt %, preferably at least 5 wt %, and in particular at least 20 wt %.

The particulate solid may a pH value (10 wt % in water) of at least 8.0, preferably at least 8.5, more preferably at least 9.0, even more preferably at least 9.5, in particular at least 10.0, even more particular at least 11.0.

The particulate solid may comprise auxiliaries such as those listed below. Preferably, the particulate solid comprises auxiliaries such as anti-foaming agents (e.g. silicones), binders, anti-drift agents, crystallization inhibitors (e.g. salts of polyacrylic acid), or separating agents. The particulate solid may comprise up to 15 wt %, preferably up to 10 wt %, and in particular up to 5 wt % auxiliaries.

Suitable separating agents are kaolinite, aluminum silicate, aluminum hydroxide, calcium carbonate, magnesium carbonate. The particulate solid may contain up to 5 wt %, preferably up to 2 wt % of the separating agent.

In a preferred form the particulate solid contains at least 80 wt % of the base (such as an alkali salt of CO₃²⁻ and/or an alkali salt of HCO₃⁻), up to 10 wt % auxiliaries (e.g. a separating agent), and has a particle size D₉₀ of up to 10 mm.

In a more preferred form the particulate solid contains at least 90 wt % of the base (such as an alkali salts of CO₃²⁻ and/or an alkali salts of HCO₃⁻), up to 5 wt % auxiliaries (e.g. a separating agent), and has a particle size D₉₀ of up to 10 mm.

The method for preparing the tank mix may comprises the step of contacting a glyphosate formulation, water, a tank mix adjuvant, and optionally an auxiliary. The glyphosate formulation may also comprise an auxiliary, which may be different or identical to the auxiliary to be added to the tank mix. Examples for auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, crystallization inhibitors, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e.g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof. Preferred solvents are organic solvents.

Suitable crystallization inhibitors are polyacrylic acids and their salts, whereas the latter are preferred. The salts of polyacrylic acids may be ammonium, primary, secondary or tetiatry ammonium derivatives, or alkali metal salts (e.g. sodium, potassium, lithium ions), wherein alkali metal salts such as sodium salts are preferred. The polyacrylic acids and their salts usually have a molecular weight (as determined by GPC, calibration with polystyrene suphonates) of 1000 Da to 300 kDa, preferably of 1000 Da to 80 kDa, and in particular 1000 Da to 15 kDa. The crystallization inhibitors are usually water-soluble, e.g. at least 1 g/l, preferably at least 10 g/l, and in particular at least 100 g/l at 20° C. The tank mix usually contains from 0.0001 to 0.2 wt %, preferably from 0.005 to 0.05 wt % of the crystallization inhibitors (e.g. salts of polyacrylic acid). The tank mix adjuvant usually contains from 0.1 to 5.0 wt %, preferably from 0.25 to 2.5 wt % of the crystallization inhibitors (e.g. salts of polyacrylic acid). In another form the tank mix adjuvant may contain up to 10 wt % of the crystallization inhibitors (e.g. salts of polyacrylic acid).

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharide powders, e.g. cellulose, starch; fertilizers, e.g. ammonium sulfate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate. Preferred nonionic surfactants are alkylpolyglucosides and alkoxylates (e.g. alkylamines, which have been alkoxylated). Preferred alkoxylates are linear or branched C₈-C₁₄ alkylamines, which have been ethoxylated. Typically, the tank mix adjuvant contains at least 10 g/l, preferably at least 50 g/l, and in particular at least 100 g/l of the non-ionic surfactants. Typically, the tank mix adjuvant contains up to 600 g/l, preferably up to 500 g/I, and in particular up to 400 g/l of the non-ionic surfactants.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide.

Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the pesticide on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids. Preferred anti-foaming agents are silicones, such as polydimethylsiloxan. Silicone based anti-foaming agents are commercially available, e.g. as KM 72 from Shin Etsu, SAG® 220 or SAG® 30 from Momentive, or Antifoam AF-30.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidones, polyvinylacetates, polyvinyl alcohols, polyacrylates, biological or synthetic waxes, and cellulose ethers.

Suitable anti-drift agents are for example nonionic polymers (such as polyacrylamides, polyethylene glycols, or guar gum with a molecular weight of at least 20 kDa, preferably at least 50 kDa, and in particular at least 100 kDa. Such products are commercially available under the tradenames Guar DV27 from Rhodia, Companion® Gold, Border® EG, Direct®, Affect® GC. Further examples for anti-drift agents are oils, such as mineral oil, plant oils, methylated seed oil; lecithin; selfemulsifiably polyesters; surfactants, such as those mentioned above. Such products are commercially available under the tradenames Termix® 5910, Wheather Guard Complete, Compadre®, Interlock®, Placement®, Silwett® L77, Hasten®, Premium® MSO, Transport® Plus, Point Blank® VM, Agridex®, Meth Oil®, Topcithin® UB, Topcithin® SB. Typically, the tank mix adjuvant contains at least 20 g/l, preferably at least 50 g/l, and in particular at least 100 g/l of the anti-drift agents. Typically, the tank mix adjuvant contains up to 400 g/l, preferably up to 300 g/l, and in particular up to 200 g/l of the anti-drift agents.

Humectans are typically compounds, which attract and/or keep water within the adjuvant. Examples for humectants are glycerol or sugar syrups, wherein sugar syrups are preferred.

Suitable sugar syrups are syrups, which contain mono-, di-, and/or oligosaccharides. Examples are glucose syrup, maltitol syrup, maltose syrup and glucose-fructose-syrup, wherein the glucose-fructose-syrup is preferred. Preferred syrups contain at least 30 wt % fructose and at least 25 wt % glucose, more preferably at least 40 wt % fructose and at least 35 wt % glucose, wherein the wt % are on a dry basis. The sugar syrups may contain water, such as up to 40 wt %, preferably up to 30 wt %. Usually, the sugar syrups are based on corn hydrolysate (so called corn syrups).

The tank mix adjuvant may comprise 5 to 70 wt %, preferably 10 to 50 wt %, and in particular 15 to 40 wt % of the humectant.

Preferred auxiliaries are anti-freezing agents, crystallization inhibitors (e.g. salts of polyacrylic acid), and surfactants (such as alkylpolyglucosides and alkoxylates (e.g. amines, which have been alkoxylated)).

Glyphosate formulations are generally known and commercially available. Glyphosate formulations usually comprise glyphosate and optionally an auxiliary. Glyphosate formulations may be any type of agrochemical formulation, such as solid or liquid formulations. Examples for composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), solutions (e.g. SL). Further examples for compositions types are listed in the “Catalogue of pesticide formulation types and international coding system”, Technical Monograph No 2, 6^{th} Ed. May 2008, CropLife International. Preferably, the glyphosate formulation is an aqueous liquid formulation, such as an SL formulation.

The glyphosate formulation may contain at least 10 wt %, preferably at least 20 wt %, and in particular at least 30 wt % of the glyphosate.

Examples for composition types and their preparation are:

i) Water-Soluble Concentrates (SL, LS)
10-60 wt % of a glyphosate and 5-15 wt % wetting agent (e.g. alcohol alkoxylates) are dissolved in water and/or in a water-soluble solvent (e.g. alcohols) up to 100 wt %. The active substance dissolves upon dilution with water.

ii) Dispersible Concentrates (DC)
5-25 wt % of a glyphosate and 1-10 wt % dispersant (e.g. polyvinylpyrrolidone) are dissolved in up to 100 wt % organic solvent (e.g. cyclohexanone). Dilution with water gives a dispersion.

iii) Emulsifiable Concentrates (EC)
15-70 wt % of a glyphosate and 5-10 wt % emulsifiers (e.g. calcium dodecylbenzenesulfonate and castor oil ethoxylate) are dissolved in up to 100 wt % water-insoluble organic solvent (e.g. aromatic hydrocarbon). Dilution with water gives an emulsion.

iv) Emulsions (EW, EO, ES)
5-40 wt % of a glyphosate and 1-10 wt % emulsifiers (e.g. calcium dodecylbenzenesulfonate and castor oil ethoxylate) are dissolved in 20-40 wt % water-insoluble organic solvent (e.g. aromatic hydrocarbon). This mixture is introduced into up to 100 wt % water by means of an emulsifying machine and made into a homogeneous emulsion. Dilution with water gives an emulsion.

v) Suspensions (SC, OD, FS)
In an agitated ball mill, 20-60 wt % of a glyphosate are comminuted with addition of 2-10 wt % dispersants and wetting agents (e.g. sodium lignosulfonate and alcohol ethoxylate), 0.1-2 wt % thickener (e.g. xanthan gum) and up to 100 wt % water to give a fine active substance suspension. Dilution with water gives a stable suspension of the active substance. For FS type composition up to 40 wt % binder (e.g. polyvinylalcohol) is added.

vi) Water-Dispersible Granules and Water-Soluble Granules (WG, SG)
50-80 wt % of a pesticide are ground finely with addition of up to 100 wt % dispersants and wetting agents (e.g. sodium lignosulfonate and alcohol ethoxylate) and prepared as water-dispersible or water-soluble granules by means of technical appliances (e.g. extrusion, spray tower, fluidized bed). Dilution with water gives a stable dispersion or solution of the glyphosate.

vii) Water-Dispersible Powders and Water-Soluble Powders (WP, SP, WS)
50-80 wt % of a glyphosate are ground in a rotor-stator mill with addition of 1-5 wt % dispersants (e.g. sodium lignosulfonate), 1-3 wt % wetting agents (e.g. alcohol ethoxylate) and up to 100 wt % solid carrier, e.g. silica gel. Dilution with water gives a stable dispersion or solution of the active substance.

viii) Gel (GW, GF)
In an agitated ball mill, 5-25 wt % of a pesticide are comminuted with addition of 3-10 wt % dispersants (e.g. sodium lignosulfonate), 1-5 wt % thickener (e.g. carboxymethylcellulose) and up to 100 wt % water to give a fine suspension of the glyphosate. Dilution with water gives a stable suspension of the active substance.

ix) Microemulsion (ME)
5-20 wt % of a glyphosate are added to 5-30 wt % organic solvent blend (e.g. fatty acid dimethylamide and cyclohexanone), 10-25 wt % surfactant blend (e.g. alkohol ethoxylate and arylphenol ethoxylate), and water up to 100%. This mixture is stirred for 1 h to produce spontaneously a thermodynamically stable microemulsion.

x) Microcapsules (CS)
An oil phase comprising 5-50 wt % of a glyphosate, 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50 wt % of a pesticide, 0-40 wt % water insoluble organic solvent (e.g. aromatic hydrocarbon), and an isocyanate monomer (e.g. diphenylmethene-4,4′-diisocyanatae) are dispersed into an aqueous solution of a protective colloid (e.g. polyvinyl alcohol). The addition of a polyamine (e.g. hexamethylenediamine) results in the formation of a polyurea microcapsules. The monomers amount to 1-10 wt %. The wt % relate to the total CS composition.

xi) Dustable Powders (DP, DS)
1-10 wt % of a glyphosate are ground finely and mixed intimately with up to 100 wt % solid carrier, e.g. finely divided kaolin.

xii) Granules (GR, FG)
0.5-30 wt % of a glyphosate is ground finely and associated with up to 100 wt % solid carrier (e.g. silicate). Granulation is achieved by extrusion, spray-drying or the fluidized bed.

xiii) Ultra-Low Volume Liquids (UL)
1-50 wt % of a glyphosate are dissolved in up to 100 wt % organic solvent, e.g. aromatic hydrocarbon.
The compositions types i) to xiii) may optionally comprise further auxiliaries, such as 0.1-1 wt % bactericides, 5-15 wt % anti-freezing agents, 0.1-1 wt % anti-foaming agents, and 0.1-1 wt % colorants.

The anionic form of glyphosate may be a contain one, two, three, or a mixture thereof, negative charges.

It is known to an expert, that the dissociation of the functional groups and thus the location of the anionic charge may depend for example on the pH, when the anionic pesticides is present in dissolved form. The acid dissociation constants pKₐ of glyphosate are typically 0.8 for the first phosphonic acid, 2.3 for the carboxylic acid, 6.0 for the second phosphonic acid, and 11.0 for the amine.

The glyphosate formulation may comprise an alkali metal salt of glyphosate, which may contain from one to to three (e.g. one, two or three) alkali metal ions, or a mixture thereof. Preferably, the alkali metal salts of glyphosate contains at least 2 equivalents (in particular two or three equivalents, or a mixture thereof) of alkali metal ions per glyphosate ion. Examples are monosodium glyphosate, monopotassium glyphosate, disodium glyphosate, trisodium glyphosate, dipotassium glyphosate, tripotassium glyphosate, or mixtures thereof. Preferred are disodium glyphosate, trisodium glyphosate, dipotassium glyphosate, tripotassium glyphosate, or mixtures thereof (e.g. a mixture of disodium glyphosate and trisodium glyphosate; or of dipotassium glyphosate and tripotassium glyphosate; or of dipotassium glyphosate, trisodium glyphosate; or of disodium glyphosate and tripotassium glyphosate).

The glyphosate formulation or the tank mix may comprise at least one further pesticide.

In a preferred form the method for preparing a tank mix comprises the step of contacting a pesticide glyphosate formulation, water, a tank mix adjuvant, and a further pesticide formulation. The term “further pesticide formulation” relates to an agrochemical formulation (e.g. the composition types i) to xi) as listed above) which comprises at least one further pesticide. Preferably the further pesticide is an anionic pesticide.

The term “pesticide” within the meaning of the invention states that one or more compounds can be selected from the group consisting of fungicides, insecticides, nematicides, herbicide and/or safener or growth regulator, preferably from the group consisting of fungicides, insecticides or herbicides, most preferably from the group consisting of herbicides. Also mixtures of pesticides of two or more the aforementioned classes can be used. The skilled artisan is familiar with such pesticides, which can be, for example, found in the Pesticide Manual, 15th Ed. (2009), The British Crop Protection Council, London.

Examples for fungicides are:

A) strobilurins
azoxystrobin, dimoxystrobin, enestroburin, fluoxastrobin, kresoxim-methyl, metominostrobin, orysastrobin, picoxystrobin, pyraclostrobin, pyrametostrobin, pyraoxystrobin, pyribencarb, trifloxystrobin, methyl(2-chloro-5-[1-(3-methylbenzyloxyimino)ethypenzyl)carbamate and 2-(2-(3-(2,6-dichlorophenyl)-1-methyl-allylideneaminooxymethyl)-phenyl)-2-methoxyiminoN-methyl-acetamide;
   B) carboxamides
carboxanilides: benalaxyl, benalaxyl-M, benodanil, bixafen, boscalid, carboxin, fenfuram, fenhexamid, flutolanil, furametpyr, isopyrazam, isotianil, kiralaxyl, mepronil, metalaxyl, metalaxyl-M (mefenoxam), ofurace, oxadixyl, oxycarboxin, penflufen, penthiopyrad, sedaxane, tecloftalam, thifluzamide, tiadinil, 2-amino-4-methyl-thiazole-5-carboxanilide, N-(3′,4′,5′-trifluorobiphenyl-2-yl)-3-difluoromethyl-1-methyl-1H-pyrazole-4-carboxamide, N-(4′-trifluoromethylthiobiphenyl-2-yl)-3-difluoromethyl-1-methyl-1H-pyrazole-4-carboxamide and N-(2-(1,3,3-trimethyl-butyl)-phenyl)-1,3-dimethyl-5-fluoro-1H-pyrazole-4-carboxamide;
carboxylic morpholides: dimethomorph, flumorph, pyrimorph;
benzoic acid amides: flumetover, fluopicolide, fluopyram, zoxamide;
other carboxamides: carpropamid, dicyclomet, mandiproamid, oxytetracyclin, silthiofarm and
N-(6-methoxy-pyridin-3-yl)cyclopropanecarboxylic acid amide;
   C) azoles
triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole;
imidazoles: cyazofamid, imazalil, pefurazoate, prochloraz, triflumizol;
benzimidazoles: benomyl, carbendazim, fuberidazole, thiabendazole;
others: ethaboxam, etridiazole, hymexazole and 2-(4-chloro-phenyl)-N-[4-(3,4-dimethoxyphenyl)-isoxazol-5-yl]-2-prop-2-ynyloxy-acetamide;
   D) heterocyclic compounds
pyridines: fluazinam, pyrifenox, 3-[5-(4-chloro-phenyl)-2,3-dimethyl-isoxazolidin-3-yl]-pyridine, 3-[5-(4-methyl-phenyl)-2,3-dimethyl-isoxazolidin-3-yl]-pyridine;
pyrimidines: bupirimate, cyprodinil, diflumetorim, fenarimol, ferimzone, mepanipyrim, nitrapyrin, nuarimol, pyrimethanil;
piperazines: triforine;
pyrroles: fenpiclonil, fludioxonil;
morpholines: aldimorph, dodemorph, dodemorph-acetate, fenpropimorph, tridemorph;
piperidines: fenpropidin;
dicarboximides: fluoroimid, iprodione, procymidone, vinclozolin;
non-aromatic 5-membered heterocycles: famoxadone, fenamidone, flutianil, octhilinone, probenazole, 5-amino-2-isopropyl-3-oxo-4-ortho-tolyl-2,3-dihydro-pyrazole-1-carbothioic acid S-allyl ester;
others: acibenzolar-S-methyl, ametoctradin, amisulbrom, anilazin, blasticidin-S, captafol, captan, chinomethionat, dazomet, debacarb, diclomezine, difenzoquat, difenzoquat-methylsulfate, fenoxanil, Folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxy-pyrimidin-2-yl)-2-methyl-1H-benzoimidazole and 5-chloro-7-(4-methylpiperidin-1-yl)-6-(2,4,6-trifluorophenyl)-[1,2,4]triazolo[1,5-a]pyrimidine;
   E) carbamates
thio- and dithiocarbamates: ferbam, mancozeb, maneb, metam, methasulphocarb, metiram, propineb, thiram, zineb, ziram;
carbamates: benthiavalicarb, diethofencarb, iprovalicarb, propamocarb, propamocarb hydrochlorid, valifenalate and N-(1-(1-(4-cyano-phenyl)ethanesulfonyl)-but-2-yl) carbamic acid-(4-fluorophenyl) ester;
   F) other active substances
guanidines: guanidine, dodine, dodine free base, guazatine, guazatine-acetate, iminoctadine, iminoctadine-triacetate, iminoctadine-tris(albesilate);
antibiotics: kasugamycin, kasugamycin hydrochloride-hydrate, streptomycin, polyoxine, validamycin A;
nitrophenyl derivates: binapacryl, dinobuton, dinocap, nitrthal-isopropyl, tecnazen, organometal compounds: fentin salts, such as fentin-acetate, fentin chloride or fentin hydroxide;
sulfur-containing heterocyclyl compounds: dithianon, isoprothiolane;
organophosphorus compounds: edifenphos, fosetyl, fosetyl-aluminum, iprobenfos, phosphorous acid and its salts, pyrazophos, tolclofos-methyl;
organochlorine compounds: chlorothalonil, dichlofluanid, dichlorophen, flusulfamide, hexachlorobenzene, pencycuron, pentachlorphenole and its salts, phthalide, quintozene, thiophanate-methyl, tolylfluanid, N-(4-chloro-2-nitro-phenyl)-N-ethyl-4-methylbenzenesulfonamide;
inorganic active substances: Bordeaux mixture, copper acetate, copper hydroxide, copper oxychloride, basic copper sulfate, sulfur;
others: biphenyl, bronopol, cyflufenamid, cymoxanil, diphenylamin, metrafenone, mildiomycin, oxin-copper, prohexadione-calcium, spiroxamine, tebufloquin, tolylfluanid, N-(cyclopropylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)phenyl)-N-ethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, methoxy-acetic acid 6-tert-butyl-8-fluoro-2,3-dimethyl-quinolin-4-yl ester and N-Methyl-2-{1-[(5-methyl-3-trifluoromethyl-1H-pyrazol-1-yl)-acetyl]-piperidin-4-yl}-N-[(1R)-1,2,3,4-tetrahydronaphthalen-1-yl]-4-thiazolecarboxamide.

Examples for growth regulators are:

Abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6-benzyladenine, paclobutrazol, prohexadione (prohexadione-calcium), prohydrojasmon, thidiazuron, triapenthenol, tributyl phosphorotrithioate, 2,3,5-tri-iodobenzoic acid, trinexapac-ethyl and uniconazole.

Examples for herbicides are:
acetamides: acetochlor, alachlor, butachlor, dimethachlor, dimethenamid, flufenacet, mefenacet, metolachlor, metazachlor, napropamide, naproanilide, pethoxamid, pretilachlor, propachlor, thenylchlor;
amino acid derivatives: bilanafos, glyphosate (e.g. glyphosate free acid, glyphosate ammonium salt, glyphosate isopropylammonium salt, glyphosate trimethylsulfonium salt, glyphosate potassium salt, glyphosate dimethylamine salt), glufosinate, sulfosate;
aryloxyphenoxypropionates: clodinafop, cyhalofop-butyl, fenoxaprop, fluazifop, haloxyfop, metamifop, propaquizafop, quizalofop, quizalofop-P-tefuryl;
Bipyridyls: diquat, paraquat;
(thio)carbamates: asulam, butylate, carbetamide, desmedipham, dimepiperate, eptam (EPTC), esprocarb, molinate, orbencarb, phenmedipham, prosulfocarb, pyributicarb, thiobencarb, triallate;
cyclohexanediones: butroxydim, clethodim, cycloxydim, profoxydim, sethoxydim, tepraloxydim, tralkoxydim;
dinitroanilines: benfluralin, ethalfluralin, oryzalin, pendimethalin, prodiamine, trifluralin;
diphenyl ethers: acifluorfen, aclonifen, bifenox, diclofop, ethoxyfen, fomesafen, lactofen, oxyfluorfen;
hydroxybenzonitriles: bomoxynil, dichlobenil, ioxynil;
imidazolinones: imazamethabenz, imazamox, imazapic, imazapyr, imazaquin, imazethapyr;
phenoxy acetic acids: clomeprop, 2,4-dichlorophenoxyacetic acid (2,4-D), 2,4-DB, dichlorprop, MCPA, MCPA-thioethyl, MCPB, Mecoprop;
pyrazines: chloridazon, flufenpyr-ethyl, fluthiacet, norflurazon, pyridate;
pyridines: aminopyralid, clopyralid, diflufenican, dithiopyr, fluridone, fluroxypyr, picloram, picolinafen, thiazopyr;
sulfonyl ureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metazosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propyl-imidazo[1,2-b]pyridazin-3-yl)sulfonyl)-3-(4,6-dimethoxy-pyrimidin-2-yl)urea;
triazines: ametryn, atrazine, cyanazine, dimethametryn, ethiozin, hexazinone, metamitron, metribuzin, prometryn, simazine, terbuthylazine, terbutryn, triaziflam;
ureas: chlorotoluron, daimuron, diuron, fluometuron, isoproturon, linuron, methabenzthiazuron, tebuthiuron;
other acetolactate synthase inhibitors: bispyribac-sodium, cloransulam-methyl, diclosulam, florasulam, flucarbazone, flumetsulam, metosulam, ortho-sulfamuron, penoxsulam, propoxycarbazone, pyribambenz-propyl, pyribenzoxim, pyriftalid, pyriminobac-methyl, pyrimisulfan, pyrithiobac, pyroxasulfone, pyroxsulam;
others: amicarbazone, aminotriazole, anilofos, beflubutamid, benazolin, bencarbazone, benfluresate, benzofenap, bentazone, benzobicyclon, bicyclopyrone, bromacil, bromobutide, butafenacil, butamifos, cafenstrole, carfentrazone, cinidon-ethlyl, chlorthal, cinmethylin, clomazone, cumyluron, cyprosulfamide, dicamba, difenzoquat, diflufenzopyr, Drechslera monoceras, endothal, ethofumesate, etobenzanid, fenoxasulfone, fentrazamide, flumiclorac-pentyl, flumioxazin, flupoxam, flurochloridone, flurtamone, indanofan, isoxaben, isoxaflutole, lenacil, propanil, propyzamide, quinclorac, quinmerac, mesotrione, methyl arsonic acid, naptalam, oxadiargyl, oxadiazon, oxaziclomefone, pentoxazone, pinoxaden, pyraclonil, pyraflufen-ethyl, pyrasulfotole, pyrazoxyfen, pyrazolynate, quinoclamine, saflufenacil, sulcotrione, sulfentrazone, terbacil, tefuryltrione, tembotrione, thiencarbazone, topramezone, (3-[2-chloro-4-fluoro-5-(3-methyl-2,6-dioxo-4-trifluoromethyl-3,6-dihydro-2H-pyrimidin-1-yl)-phenoxy]-pyridin-2-yloxy)-acetic acid ethyl ester, 6-amino-5-chloro-2-cyclopropyl-pyrimidine-4-carboxylic acid methyl ester, 6-chloro-3-(2-cyclopropyl-6-methylphenoxy)-pyridazin-4-ol, 4-amino-3-chloro-6-(4-chloro-phenyl)-5-fluoro-pyridine-2-carboxylic acid, 4-amino-3-chloro-6-(4-chloro-2-fluoro-3-methoxy-phenyl)-pyridine-2-carboxylic acid methyl ester, and 4-amino-3-chloro-6-(4-chloro-3-dimethylamino-2-fluoro-phenyl)-pyridine-2-carboxylic acid methyl ester.

Examples for insecticides are:
organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methylparathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
pyrethroids: allethrin, bifenthrin, cyfluthrin, cyhalothrin, cyphenothrin, cypermethrin, alphacypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;
insect growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;
nicotinic receptor agonists/antagonists compounds: clothianidin, dinotefuran, imidacloprid, thiamethoxam, nitenpyram, acetamiprid, thiacloprid, 1-(2-chloro-thiazol-5-ylmethyl)-2-nitrimino-3,5-dimethyl-[1,3,5]triazinane;
GABA antagonist compounds: endosulfan, ethiprole, fipronil, vaniliprole, pyrafluprole, pyriprole, 5-amino-1-(2,6-dichloro-4-methyl-phenyl)-4-sulfinamoyl-1H-pyrazole-3-carbothioic acid amide;
macrocyclic lactone insecticides: abamectin, emamectin, milbemectin, lepimectin, spinosad, spinetoram;
mitochondrial electron transport inhibitor (METI) I acaricides: fenazaquin, pyridaben, tebufenpyrad, tolfenpyrad, flufenerim;
METI II and III compounds: acequinocyl, fluacyprim, hydramethylnon;
Uncouplers: chlorfenapyr;
oxidative phosphorylation inhibitors: cyhexatin, diafenthiuron, fenbutatin oxide, propargite;
moulting disruptor compounds: cryomazine;
mixed function oxidase inhibitors: piperonyl butoxide;
sodium channel blockers: indoxacarb, metaflumizone;
others: benclothiaz, bifenazate, cartap, flonicamid, pyridalyl, pymetrozine, sulfur, thiocyclam, flubendiamide, chlorantraniliprole, cyazypyr (HGW86), cyenopyrafen, flupyrazofos, cyflumetofen, amidoflumet, imicyafos, bistrifluron, and pyrifluquinazon.

The further pesticide may be dissolved or dispersed in the tank mix. Preferably, the further pesticide is an auxin herbicide which is dissolved in the tank mix.

The further pesticide, such as the auxin herbicide, has often a solubility in water at 20° C. of at least 10 g/l, preferably of at least 50 g/l, and in particular of at least 100 g/l.

In another preferred form the further pesticide comprises a growth regulator, such as prohexadione (especially prohexadione calcium).

In another preferred form the further pesticide contains a anionic pesticide. The term “anionic pesticide” refers to a pesticide, which is present as an anion. Preferably, anionic pesticides relate to pesticides comprising a protonizable hydrogen. More preferably, anionic pesticides relate to pesticides comprising a carboxylic, thiocarbonic, sulfonic, sulfinic, thiosulfonic, phosphinic, or phosphorous acid group, especially a carboxylic acid group. The aforementioned groups may be partly present in neutral form including the protonizable hydrogen.

Usually, anions such as anionic pesticides comprise at least one anionic group. Preferably, the anionic pesticide comprises one or two anionic groups. In particular the anionic pesticide comprises exactly one anionic group. An example of an anionic group is a carboxylate group (—C(O)O—). The aforementioned anionic groups may be partly present in neutral form including the protonizable hydrogen. For example, the carboxylate group may be present partly in neutral form of carboxylic acid (—C(O)OH). This is preferably the case in aqueous compositions, in which an equilibrium of carboxylate and carboxylic acid may be present.

Suitable anionic pesticides are given in the following. In case the names refer to a neutral form or a salt of the anionic pesticide, the anionic form of the anionic pesticides are meant. For example, the anionic form of dicamba may be represented by the following formula:

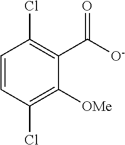 [SMILES: COc1c(Cl)ccc(Cl)c1C(=O)[O-]]

Suitable anionic pesticides are herbicides, which comprise a carboxylic, thiocarbonic, sulfonic, sulfinic, thiosulfonic or phosphorous acid group, especially a carboxylic acid group. Examples are aromatic acid herbicides, phenoxycarboxylic acid herbicides or organophosphorous herbicides comprising a carboxylic acid group.

Suitable aromatic acid herbicides are benzoic acid herbicides, such as diflufenzopyr, naptalam, chloramben, dicamba, 2,3,6-trichlorobenzoic acid (2,3,6-TBA), tricamba; pyrimidinyloxybenzoic acid herbicides, such as bispyribac, pyriminobac; pyrimidinylthiobenzoic acid herbicides, such as pyrithiobac; phthalic acid herbicides, such as chlorthal; picolinic acid herbicides, such as aminopyralid, clopyralid, picloram; quinolinecarboxylic acid herbicides, such as quinclorac, quinmerac; or other aromatic acid herbicides, such as aminocyclopyrachlor. Preferred are benzoic acid herbicides, especially dicamba.

Suitable phenoxycarboxylic acid herbicides are phenoxyacetic herbicides, such as 4-chlorophenoxyacetic acid (4-CPA), (2,4-dichlorophenoxy)acetic acid (2,4-D), (3,4-dichlorophenoxy)acetic acid (3,4-DA), MCPA (4-(4-chloro-o-tolyloxy)butyric acid), MCPA-thioethyl, (2,4,5-trichlorophenoxy)acetic acid (2,4,5-T); phenoxybutyric herbicides, such as 4-CPB, 4-(2,4-dichlorophenoxy)butyric acid (2,4-DB), 4-(3,4-dichlorophenoxy)butyric acid (3,4-DB), 4-(4-chloro-o-tolyloxy)butyric acid (MCPB), 4-(2,4,5-trichlorophenoxy)butyric acid (2,4,5-TB); phenoxypropionic herbicides, such as cloprop, 2-(4-chlorophenoxy)propanoic acid (4-CPP), dichlorprop, dichlorprop-P, 4-(3,4-dichlorophenoxy)butyric acid (3,4-DP), fenoprop, mecoprop, mecoprop-P; aryloxyphenoxypropionic herbicides, such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, trifop. Preferred are phenoxyacetic herbicides, especially 2,4-D.

The term “organophosphorous herbicides” usually refers to herbicides containing a phosphinic or phosphorous acid group. Suitable organophosphorous herbicides comprising a carboxylic acid group are bialafos, glufosinate, glufosinate-P.

Suitable other herbicides comprising a carboxylic acid are pyridine herbicides comprising a carboxylic acid, such as fluroxypyr, triclopyr; triazolopyrimidine herbicides comprising a carboxylic acid, such as cloransulam; pyrimidinylsulfonylurea herbicides comprising a carboxylic acid, such as bensulfuron, chlorimuron, foramsulfuron, halosulfuron, mesosulfuron, primisulfuron, sulfometuron; imidazolinone herbicides, such as imazamethabenz, imazamethabenz, imazamox, imazapic, imazapyr, imazaquin and imazethapyr; triazolinone herbicides such as flucarbazone, propoxycarbazone and thiencarbazone; aromatic herbicides such as acifluorfen, bifenox, carfentrazone, flufenpyr, flumiclorac, fluoroglycofen, fluthiacet, lactofen, pyraflufen. Further on, chlorflurenol, dalapon, endothal, flamprop, flamprop-M, flupropanate, flurenol, oleic acid, pelargonic acid, TCA may be mentioned as other herbicides comprising a carboxylic acid.

Suitable anionic pesticides are fungicides, which comprise a carboxylic, thiocarbonic, sulfonic, sulfinic, thiosulfonic or phosphorous acid group, especially a carboxylic acid group. Examples are polyoxin fungicides, such as polyoxorim.

Suitable anionic pesticides are insecticides, which comprise a carboxylic, thiocarbonic, sulfonic, sulfinic, thiosulfonic or phosphorous acid group, especially a carboxylic acid group. Examples are thuringiensin.

Suitable anionic pesticides are plant growth regulator, which comprise a carboxylic, thiocarbonic, sulfonic, sulfinic, thiosulfonic or phosphorous acid group, especially a carboxylic acid group. Examples are 1-naphthylacetic acid, (2-naphthyloxy)acetic acid, indol-3-ylacetic acid, 4-indol-3-ylbutyric acid, glyphosine, jasmonic acid, 2,3,5-triiodobenzoic acid, prohexadione, trinexapac, preferably prohexadione and trinexapac.

Preferred anionic pesticides are anionic herbicides, more preferably dicamba, glyphosate, 2,4-D, aminopyralid, aminocyclopyrachlor and MCPA. Especially preferred are dicamba and glyphosate. In another preferred embodiment, dicamba is preferred. In another preferred embodiment, 2,4-D is preferred. In another preferred embodiment, glyphosate is preferred. In another preferred embodiment, MCPA is preferred.

In another preferred form the further pesticide comprises an auxin herbicide. Various synthetic and natural auxin herbicides are known, wherein synthetic auxin herbicides are preferred. Preferably, the auxin herbicide comprises a protonizable hydrogen. More preferably, auxin herbicides relate to pesticides comprising a carboxylic, thiocarbonic, sulfonic, sulfinic, thiosulfonic or phosphorous acid group, especially a carboxylic acid group. The aforementioned groups may be partly present in neutral form including the protonizable hydrogen. Examples for natural auxin herbicides are indole-3acetic acid (IAA), phenyl acetic acid (PAA), 4-chloroindole-3-acetic acid (4-CI-IAA), and indole-3-butanoic acid (IBA). Examples for synthetic auxin herbicides are 2,4-D and its salts, 2,4-DB and its salts, aminopyralid and its salts such as aminopyralid-tris(2-hydroxypropyl)ammonium, benazolin, chloramben and its salts, clomeprop, clopyralid and its salts, dicamba and its, dichlorprop and its salts, dichlorprop-P and its salts, fluroxypyr, MCPA and its salts, MCPA-thioethyl, MCPB and its salts, mecoprop and its salts, mecoprop-P and its salts, picloram and its salts, quinclorac, quinmerac, TBA (2,3,6) and its salts, triclopyr and its salts, and aminocyclopyrachlor and its salts. Preferred auxin herbicides are 2,4-D and its salts, and dicamba and its salts, wherein dicamba is more preferred. In another more preferred form, the auxin herbicide contains an alkali metal salt of dicamba, such as sodium and/or potassium. Mixtures of the aforementioned auxin herbicides are also possible.

In another preferred form the pesticide contains organophosphorous herbicides (e.g. herbicides containing a phosphinic or phosphorous acid group) comprising a carboxylic acid group. Especially preferred further pesticides are bilanafos, glufosinate, glufosinate-P, and one or more pesticides from the class of imidazolinones.

In a preferred form, the auxin herbicide contains an alkali metal salt of dicamba (such as sodium and/or potassium) and glyphosate, which contains an alkali metal salt of glyphosate (such as sodium and/or potassium glyphosate).

In a preferred form, the glyphosate formulation comprises glyphosate, the tank mix adjuvant comprises a base selected from K₂CO₃, KHCO₃, or a mixture of thereof, and the tank mix comprises an auxiliary selected from alkoxylates (e.g. linear or branched C₈-C₁₄ alkylamines, which have been ethoxylated), alkylpolyglucosides and crystallization inhibitors (e.g. salts of polyacrylic acid).

In another preferred form, the glyphosate formulation comprises glyphosate and an auxin herbicide (e.g. dicamba or 2,4-D), the tank mix adjuvant comprises a base selected from K₂CO₃, KHCO₃, or a mixture of thereof, and the tank mix comprises an auxiliary selected from alkoxylates (e.g. linear or branched C₈-C₁₄ alkylamines, which have been ethoxylated), alkylpolyglucosides, and crystallization inhibitors (e.g. salts of polyacrylic acid).

The present invention also relates to a method of controlling phytopathogenic fungi and/or undesired vegetation and/or undesired insect or mite attack and/or for regulating the growth of plants, wherein the tank mix is allowed to act on the respective pests, their environment or the plants to be protected from the respective pest, on the soil and/or on undesired plants and/or the crop plants and/or their environment.

Examples of suitable crops and plants to be protected are the following:

Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Brassica juncea, Brassica campestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays.

Preferred crops are: Arachis hypogaea, Beta vulgaris spec. altissima, Brassica napus var. napus, Brassica oleracea, Brassica juncea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays.

The method according to the invention can preferably be used in genetically modified crops. The term “genetically modified crops” is to be understood as plants, which genetic material has been modified by the use of recombinant DNA techniques in a way that under natural circumstances it cannot readily be obtained by cross breeding, mutations, natural recombination, breeding, mutagenesis, or genetic engineering. Typically, one or more genes have been integrated into the genetic material of a genetically modified plant in order to improve certain properties of the plant. Such genetic modifications also include but are not limited to targeted post-transitional modification of protein(s), oligo- or polypeptides e.g. by glycosylation or polymer additions such as prenylated, acetylated or farnesylated moieties or PEG moieties.

Plants that have been modified by breeding, mutagenesis or genetic engineering, e.g. have been rendered tolerant to applications of specific classes of herbicides, are particularly useful with the composition and method according to the invention. Tolerance to classes of herbicides has been developed such as auxin herbicides such as dicamba or 2,4-D (i.e. auxin tolerant crops); bleacher herbicides such as hydroxyphenylpyruvate dioxygenase (HPPD) inhibitors or phytoene desaturase (PDS) inhibitors; acetolactate synthase (ALS) inhibitors such as sulfonyl ureas or imidazolinones; enolpyruvyl shikimate 3-phosphate synthase (EPSP) inhibitors such as glyphosate; glutamine synthetase (GS) inhibitors such as glufosinate; protoporphyrinogen-IX oxidase (PPO) inhibitors; lipid biosynthesis inhibitors such as acetyl CoA carboxylase (ACCase) inhibitors; or oxynil (i. e. bromoxynil or ioxynil) herbicides as a result of conventional methods of breeding or genetic engineering. Furthermore, plants have been made resistant to multiple classes of herbicides through multiple genetic modifications, such as resistance to both glyphosate and glufosinate or to both glyphosate and a herbicide from another class such as ALS inhibitors, HPPD inhibitors, auxin herbicides, or ACCase inhibitors. These herbicide resistance technologies are, for example, described in Pest Management Science 61, 2005, 246; 61, 2005, 258; 61, 2005, 277; 61, 2005, 269; 61, 2005, 286; 64, 2008, 326; 64, 2008, 332; Weed Science 57, 2009, 108; Australian Journal of Agricultural Research 58, 2007, 708; Science 316, 2007, 1185; and references quoted therein. Examples of these herbicide resistance technologies are also described in US 2008/0028482, US2009/0029891, WO 2007/143690, WO 2010/080829, U.S. Pat. No. 6,307,129, U.S. Pat. No. 7,022,896, US 2008/0015110, U.S. Pat. No. 7,632,985, U.S. Pat. No. 7,105,724, and U.S. Pat. No. 7,381,861, each herein incorporated by reference.

Several cultivated plants have been rendered tolerant to herbicides by conventional methods of breeding (mutagenesis), e.g. Clearfield® summer rape (Canola, BASF SE, Germany) being tolerant to imidazolinones, e.g. imazamox, or ExpressSun® sunflowers (DuPont, USA) being tolerant to sulfonyl ureas, e.g. tribenuron. Genetic engineering methods have been used to render cultivated plants such as soybean, cotton, corn, beets and rape, tolerant to herbicides such as glyphosate, dicamba, imidazolinones and glufosinate, some of which are under development or commercially available under the brands or trade names RoundupReady® (glyphosate tolerant, Monsanto, USA), Cultivance® (imidazolinone tolerant, BASF SE, Germany) and LibertyLink® (glufosinate tolerant, Bayer CropScience, Germany).

Preferably, the crops are genetically modified crops, that are tolerant at least to auxins, in particular crops which are tolerant at least to dicamba or 2,4-D. In a preferred form the crops are tolerant to auxins (e.g. dicamba or 2,4-D) and to glyphosate.

Furthermore, plants are also covered that are by the use of recombinant DNA techniques capable to synthesize one or more insecticidal proteins, especially those known from the bacterial genus Bacillus, particularly from Bacillus thuringiensis, such as ä-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be under-stood expressly also as pre-toxins, hybrid proteins, truncated or otherwise modified proteins. Hybrid proteins are characterized by a new combination of protein domains, (see, e.g. WO 02/015701). Further examples of such toxins or genetically modified plants capable of synthesizing such toxins are dis-closed, e.g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e.g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal pro-teins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e.g. Agrisure® CB) and Bt176 from Syngenta Seeds SAS, France, (corn cultivars producing the Cry1Ab toxin and PAT enyzme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesisrelated proteins” (PR proteins, see, e.g. EP-A 392 225), plant disease resistance genes (e.g. potato culti-vars, which express resistance genes acting against Phytophthora infestans derived from the mexican wild potato Solanum bulbocastanum) or T4-lyso-zym (e.g. potato cultivars capable of synthesizing these proteins with increased resistance against bacteria such as Erwinia amylvora). The methods for producing such genetically modi-fied plants are generally known to the person skilled in the art and are described, e.g. in the publications mentioned above.

Furthermore, plants are also covered that are by the use of recombinant DNA techniques capable to synthesize one or more proteins to increase the productivity (e.g. bio mass production, grain yield, starch content, oil content or protein content), tolerance to drought, salinity or other growth-limiting environ-mental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e.g. oil crops that produce health-promoting long-chain omega-3 fatty acids or unsaturated omega-9 fatty acids (e.g. Nexera® rape, DOW Agro Sciences, Canada).

Furthermore, plants are also covered that contain by the use of recombinant DNA techniques a modified amount of substances of content or new substances of content, specifically to improve raw material production, e.g. potatoes that produce increased amounts of amylopectin (e.g. Amflora® potato, BASF SE, Germany).

Furthermore, it has been found that the composition and method according to the invention are also suitable for the defoliation and/or desiccation of plant parts, for which crop plants such as cotton, potato, oilseed rape, sunflower, soybean or field beans, in particular cotton, are suitable. In this regard compositions have been found for the desiccation and/or defoliation of plants, processes for preparing these compositions, and methods for desiccating and/or defoliating plants using the composition and method according to the invention.

As desiccants, the composition and method according to the invention are suitable in particular for desiccating the above-ground parts of crop plants such as potato, oilseed rape, sunflower and soybean, but also cereals. This makes possible the fully mechanical harvesting of these important crop plants.

Also of economic interest is the facilitation of harvesting, which is made possible by concentrating within a certain period of time the dehiscence, or reduction of adhesion to the tree, in citrus fruit, olives and other species and varieties of pomaceous fruit, stone fruit and nuts. The same mechanism, i.e. the promotion of the development of abscission tissue between fruit part or leaf part and shoot part of the plants is also essential for the controlled defoliation of useful plants, in particular cotton. Moreover, a shortening of the time interval in which the individual cotton plants mature leads to an increased fiber quality after harvesting.

The composition and method according to the invention can be applied pre- or post-emergence, or together with the seed of a crop plant. It is also possible to apply the compounds and compositions by applying seed, pretreated with a composition of the invention, of a crop plant. If the active compounds A and C and, if appropriate C, are less well tolerated by certain crop plants, application techniques may be used in which the herbicidal compositions are sprayed, with the aid of the spraying equipment, in such a way that as far as possible they do not come into contact with the leaves of the sensitive crop plants, while the active compounds reach the leaves of undesirable plants growing underneath, or the bare soil surface (post-directed, lay-by).

The term “growth stage” refers to the growth stages as defined by the BBCH Codes in “Growth stages of mono- and dicotyledonous plants”, 2nd edition 2001, edited by Uwe Meier from the Federal Biological Research Centre for Agriculture and Forestry. The BBCH codes are a well established system for a uniform coding of phonologically simi-lar growth stages of all mono- and dicotyledonous plant species. In some countries related codes are known for specific crops. Such codes may be correlated to the BBCH code as exemplified by Harell et al., Agronomy J. 1998, 90, 235-238.

The tank mix may be allowed to act on crops at any growth stage, such as at BBCH Code 0, 1, 2, 3, 4, 5, 6 and/or 7. Preferably, the tank mix is allowed to act on crops at a growth stage of BBCH Code 0, 1 and/or 2, or their habitat. In another preferred form, the tank mix is allowed to act on crops at a growth stage of BBCH Code 1, 2, 3, 4, 5, 6 and/or 7, especially 2, 3, 4, 5, 6 and/or 7.

The treatment of crop with a pesticide may be done by applying said pesticide by ground or aerial application, preferably by ground application. Suitable application devices are a predosage device, a knapsack sprayer, a spray tank or a spray plane. Preferably the treatment is done by ground application, for example by a predosage device, a knapsack sprayer or a spray tank. The ground application may be done by a user walking through the crop field or with a motor vehicle, preferably with a motor vehicle.

The term “effective amount” denotes an amount of the tank mix, which is sufficient for controlling undesired vegetation and which does not result in a substantial damage to the treated crops. Such an amount can vary in a broad range and is dependent on various factors, such as the species to be controlled, the treated cultivated plant or habitat, the climatic conditions and the pesticide.

The tank mix is typically applied at a volume of 5 to 5000 l/ha, preferably of 50 to 500 l/ha.

The tank mix is typically applied at a rate of 5 to 3000 g/ha pesticide (e.g. dicamba), preferably 20 to 1500 g/ha.

The tank mix is typically applied at a rate of 0.1 to 10 kg/ha base, preferably 0.2 to 5 kg/ha.

In a further embodiment, the composition or method according to the invention can be applied by treating seed. The treatment of seed comprises essentially all procedures familiar to the person skilled in the art (seed dressing, seed coating, seed dusting, seed soaking, seed film coating, seed multilayer coating, seed encrusting, seed dripping and seed pelleting) based on the composition and method according to the invention. Here, the herbicidal compositions can be applied diluted or undiluted.

The term seed comprises seed of all types, such as, for example, corns, seeds, fruits, tubers, seedlings and similar forms. Here, preferably, the term seed describes corns and seeds.

The seed used can be seed of the useful plants mentioned above, but also the seed of transgenic plants or plants obtained by customary breeding methods.

The rates of application of the active compound are from 0.0001 to 3.0, preferably 0.01 to 1.0 kg/ha of active substance (a.s.), depending on the control target, the season, the target plants and the growth stage. To treat the seed, the pesticides are generally employed in amounts of from 0.001 to 10 kg per 100 kg of seed.

The present invention also relates to a use of the tank mix adjuvant for increasing the efficacy of a pesticide, wherein the tank mix adjuvant comprises a base selected from a carbonate and/or a phosphate, and wherein the tank mix adjuvant is present in form of an aqueous liquid, which contains at least 200 g/l of the base, or in form of a particulate solid, which contains at least 50 wt % of the base.

The present invention also relates to a tank mix adjuvant which comprises the auxiliary and the base selected from a carbonate and/or a phosphate, wherein the tank mix adjuvant is present in form of an aqueous liquid, which contains at least 200 g/l of the base. The auxiliary in the aqueous liquid may be selected from anti-freezing agents (e.g. glycerin), anti-foaming agents (e.g. silicones), anti-drift agents or binders.

The present invention also relates to a tank mix adjuvant which comprises the auxiliary and the base selected from a carbonate and/or a phosphate, wherein the tank mix adjuvant is present in form of an aqueous liquid, which contains at least 50 g/l of the base, and wherein the auxiliary is a humectant (preferably a sugar syrup). The present invention also relates to a tank mix adjuvant which comprises the auxiliary and the base selected from a carbonate or an alkali salt of a phosphate, wherein the tank mix adjuvant is present in form of an aqueous liquid, which contains at least 50 g/l of the base, and wherein the auxiliary is a humectant (preferably a sugar syrup). Preferably, the tank mix adjuvant comprises the auxiliary and the base selected from a carbonate and/or a phosphate (preferably a carbonate), wherein the tank mix adjuvant is present in form of an aqueous liquid, which contains at least 200 g/l (preferably at least 230 g/l) of the base, and wherein the auxiliary is a humectant (preferably a sugar syrup), and wherein the tank mix adjuvant comprises 5 to 70 wt % (preferably at least 15 wt %, more preferably at least 30 wt %, and in particular at least 40 wt %) of the humectant.

The present invention also relates to a method of controlling phytopathogenic fungi and/or undesired vegetation and/or undesired insect or mite attack and/or for regulating the growth of plants, wherein a pesticide formulation and the tank mix adjuvant is allowed to act on the respective pests, their environment or the plants to be protected from the respective pest, on the soil and/or on undesired plants and/or the crop plants and/or their environment, and wherein the tank mix adjuvant comprises the auxiliary and the base selected from a carbonate and/or a phosphate, wherein the tank mix adjuvant is present in form of an aqueous liquid, which contains at least 50 g/l of the base, and wherein the auxiliary is a humectant (preferably a sugar syrup). The pesticide formulation may be selected from the glyphosate formulation or the further pesticide formulations. Preferably, the pesticide formulation is a glyphosate formulation.

The present invention also relates to a tank mix adjuvant which comprises the auxiliary and the base selected from a carbonate and/or a phosphate, wherein the tank mix adjuvant is present in form in form of a particulate solid, which contains at least 50 wt % of the base. The auxiliary in the particulate solid may be selected from anti-foaming agents (e.g. silicones), binders, anti-drift agents, or separating agents.

The invention offers various advantages: There is a very low rate of unwanted phytotoxic damage in neighboring areas in which other crops (e.g. dicotyledon crops) grow; the pesticidal effect of the glyphosate is increased; the tank mix adjuvants are easy and safe to handle and to apply; the volatility of the glyphosate and optionally the further pesticides (e.g. auxin herbicides) is decreased; the efficacy of pesticides (e.g. glyphosate), which are sensitive to multivalent cations like Ca²⁺ or Mg²⁺ is conserved; the invention is very safe to crops; the low volatility of the further pesticides (e.g. auxin herbicides) is preserved or even decreased also after addition of anionic pesticides comprising mono- or diamine cations (e.g. isopropylamine glyphosate, dimethylamine glyphosate, ammonium glyphosate).

### EXAMPLES

Surfactant A: Nonionic C8/10 alkylpolyglycosid (about 70 wt % active content and 30 wt % water), viscous liquid, water-soluble, HLB 13-14.
Surfactant B: Nonionic, branched, ethoxylated alkylamine, soluble in water.
Additive A: Water-soluble sodium salt of polyacrylic acid, molar mass 7-10 kDa, K-value about 25-30, solution in water (45 wt %).
Antidrift A: Termix® 5910, commercially available from Huntsman, liquid at 25° C., density at 25° C. 0.99 g/ml; pour point −28° C., pH 6-8 (1% in water), viscosity 207 mPas (20° C.).
Humectant A: High fructrose corn syrup, total solids 75-80%, 55% fructose and 41% dextrose on dry basis, moisture 21-25%.
Clarity®: Agrochemical formulation of dicamba salt of 2-(-aminoethoxy)ethanol (watersoluble concentrate SL, 480 g/l, commercially available from BASF Corporation).
Banvel®: Agrochemical formulation of dicamba salt of dimethylamine (watersoluble concentrate SL, 48.2 wt %, commercially available from BASF Corporation).
Touchdown® HiTech: Agrochemical formulation of glyphosate potassium salt (watersoluble concentrate SL, 500 g/l, commercially available from Syngenta).

### Example 1

### Preparation of Liquid Tank Mix Adjuvant

a) 400 g K₂CO₃ and 40 g KHCO₃ were dissolved in water at room temperature and filled up with water to a volume of 1.0 l. The aqueous solution had a pH of 11.
b) 200 g KHCO₃ was dissolved in water at room temperature and filled up with water to a volume of 1.0 l. The aqueous solution had a pH of 8 to 9.
c) 400 g K₂CO₃ was dissolved in water at room temperature and filled up with water to a volume of 1.0 l. The aqueous solution had a pH of 12.
d) 300 g K₂CO₃, 300 g Surfactant A and 10 g Antidrift A were dissolved in water at room temperature and filled up with water to a volume of 1.0 l. The aqueous solution had a pH of 12.
e) 250 g K₂CO₃, 300 g Surfactant A and 10 g Antidrift A were dissolved in water at room temperature and filled up with water to a volume of 1.0 l. The aqueous solution had a pH of 12.
f) 250 g K₂CO₃, 25 g KHCO₃, 25 g Surfactant B and 150 g Surfactant A were dissolved in water at room temperature and filled up with water to a volume of 1.0 l. The aqueous solution had a pH of 11.
g) 270 g K₂CO₃, 30 g KHCO₃, 10 g Additive A are dissolved in water at room temperature and filled up with water to a volume of 1.0 l.
h) 300 g K₂CO₃ and 10 g Additive A are dissolved in water at room temperature and filled up with water to a volume of 1.0 l.
i) 200 g KH₂PO₄ and 10 g Additive A are dissolved in water at room temperature and filled up with water to a volume of 1.0 l.
j) 200 g K₂HPO₄ and 10 g Additive A are dissolved in water at room temperature and filled up with water to a volume of 1.0 l.
k) 250 g K₂CO₃ and 500 g Humectant A were dissolved in water at room temperature and filled up with water to a volume of 1.0 l.
l) 300 g K₂CO₃ and 500 g Humectant A were dissolved in water at room temperature and filled up with water to a volume of 1.0 l.
m) 350 g K₂CO₃ and 500 g Humectant A were dissolved in water at room temperature and filled up with water to a volume of 1.0 l.
n) 400 g K₂CO₃ and 500 g Humectant A were dissolved in water at room temperature and filled up with water to a volume of 1.0 l.

### Example 2

### Preparation of Granulated Tank Mix Adjuvant

A mixture of 900 g K₂CO₃ and 100 g KHCO₃ were provided in a fluidized bed granulator. 100 ml of a 10 wt % aqueous suspension of kaolin were sprayed into the fluidized bed. Water was simultaneously removed by a stream of hot air (100° C.). After sieving a dried particulated product was obtained with a particle size D₉₀ below 10 mm.

### Example 3

### Preparation of Particulated Tank Mix Adjuvant

900 g K₂CO₃ and 100 g KHCO₃ were dry mixed in a mixing plant. After sieving a homogenous mixture was obtained with a with a particle size D₉₀ below 10 mm.

### Example 4

### Preparation of Tank Mix

A sprayable tank mix is prepared by mixing at 20° C. while stirring a commercial SL formulation (Touchdown® Hitech), water, and the tank mix adjuvants of Examples 1, 2, or 3. The concentration of the pesticide is 1, 5, or 15 g/l, respectively, and the concentration of the dissolved base is 3, 30 or 50 g/l, respectively, in the tank mix.

### Example 5

### Preparation of Tankmix

Comparative examples a) to d):
a) An aqueous formulation (SL type) containing potassium glyphosate was mixed with water and tallowamine ethoxylate (15 EO). The tank mix contained 0.67 g/l glyphosate and 0.8 g/l of the tallowamine ethoxylate.
b) An aqueous formulation (SL type) containing potassium glyphosate was mixed with water and tallowamine ethoxylate (15 EO). The tank mix contained 0.33 g/l glyphosate and 0.8 g/l of the tallowamine ethoxylate.
c) An aqueous formulation (SL type) containing potassium glyphosate was mixed with water and tallowamine ethoxylate (5 EO). The tank mix contained 0.67 g/l glyphosate and 0.8 g/l of the tallowamine ethoxylate.
d) An aqueous formulation (SL type) containing potassium glyphosate was mixed with water and tallowamine ethoxylate (5 EO). The tank mix contained 0.33 g/l glyphosate and 0.8 g/l of the tallowamine ethoxylate.

Inventive examples e) to h):
e) An aqueous formulation (SL type) containing potassium glyphosate was mixed with water, K₂CO₃ and tallowamine ethoxylate (15 EO). The tank mix contained 0.67 g/l glyphosate, 0.8 g/l of the tallowamine ethoxylate, and 2.67 g/l K₂CO₃.
f) An aqueous formulation (SL type) containing potassium glyphosate was mixed with water, K₂CO₃ and tallowamine ethoxylate (15 EO). The tank mix contained 0.33 g/l glyphosate, 0.8 g/l of the tallowamine ethoxylate and 2.67 g/l K₂CO₃.
g) An aqueous formulation (SL type) containing potassium glyphosate was mixed with water, K₂CO₃ and tallowamine ethoxylate (5 EO). The tank mix contained 0.67 g/l glyphosate, 0.8 g/l of the tallowamine ethoxylate and 2.67 g/l K₂CO₃.
h) An aqueous formulation (SL type) containing potassium glyphosate was mixed with water, K₂CO₃ and tallowamine ethoxylate (5 EO). The tank mix contained 0.33 g/l glyphosate, 0.8 g/l of the tallowamine ethoxylate and 2.67 g/l K₂CO₃.

### Example 6

### Biological Evaluation

For the greenhouse tests, maize (cultivar Amadeo) and Chenopodium album was sown or potted in loamy sandy soil to a depth of 1-2 cm. When the plants had reached a growth height of 10 to 25 cm (around 10 to 21 days after sowing), the spray mixtures were applied to the plants in a spraying cabin.

The tank mixes prepared in Example 5 were applied at an application rate of 375 l/ha (140 or 280 g of glyphosate free acid/ha and 300 g of adjuvant/ha). The adjuvant Ad1 is an aqeuous solution of 200 g/l Genamin® T150 (a tallow fatty amine ethoxylate with 15 EO). The adjuvant Ad2 is Genamin® T050 (a tallow fatty amine ethoxylate with 5 EO).

The temperatures in the experimental period, which lasted for 3 to 4 weeks, were between 18-35° C. During this time, the experimental plants received optimum watering, with nutrients being supplied via the water used for watering.

The herbicidal activity was evaluated by awarding scores to the treated plants in comparison to the untreated control plants (Table 1 and 2). The evaluation scale ranges from 0% to 100% activity. 100% activity means the complete death at least of those parts of the plant that are above ground. Conversely, 0% activity means that there were no differences between treated and untreated plants. The results demonstrated the increased activity of the active substance as a result of addition of the adjuvant.

TABLE 1
Activity [%] after 21 days DAT (125
g/ha application rate of active)

| | Maize Amadeo |
|---|---|
| Gly-K + Ad1^{a)} | 57 |
| Gly-K + Ad1 + K₂CO₃ | 82 |
| Gly-K + Ad2^{a)} | 55 |
| Gly-K + Ad2 + K₂CO₃ | 65 |

^{a)}Comparative experiment.

TABLE 2
Activity [%] after 21 days DAT (250
g/ha application rate of active)

| | Chenopodium album |
|---|---|
| Gly-K + Ad1^{a)} | 87 |
| Gly-K + Ad1 + K₂CO₃ | 91 |
| Gly-K + Ad2^{a)} | 80 |
| Gly-K + Ad2 + K₂CO₃ | 98 |

^{a)}Comparative experiment.

### Example 7

### Biological Evaluation

The biological evaluation was made as described in Example 6. The water used was hard water having a hardness of 25° dH. A tank mix (“Mix A”) was applied with an application volume of 100 l/ha and with an application rate of 125 g/ha potassium glyphosate, 62.5 g/ha sodium dicamba, 300 g/ha Genamin® T150, 300 g/l Preference® (an alkylphenol ethoxylate, sodium salts of soya fatty acids, isopropyl alcohol) and optionally 1000 g/ha K₂CO₃ (“Mix A+K₂CO₃”). The results are summarized in Table 3.

TABLE 3
Activity [%]

| Plant | DAT | Mix A ^{a)} | Mix A + K₂CO₃ |
|---|---|---|---|
| Sorghum halepense | 7 | 60 | 88 |
| Sorghum halepense | 14 | 55 | 92 |
| Sorghum halepense | 21 | 50 | 92 |
| Eleusine gracilis | 7 | 73 | 78 |
| Eleusine gracilis | 14 | 78 | 92 |
| Eleusine gracilis | 21 | 80 | 97 |
| Chenopodium album | 7 | 75 | 82 |
| Chenopodium album | 14 | 87 | 90 |
| Chenopodium album | 21 | 93 | 97 |
| Zea mays (Amadeo) | 7 | 20 | 52 |
| Zea mays (Amadeo) | 14 | 37 | 68 |
| Zea mays (Amadeo) | 21 | 42 | 80 |

^{a)} Comparative experiment.

### Example 8

### Biological Evaluation of Low Phytotoxicity

The biological evaluation was made as described in Example 6. The tank mixes were applied at a application rate of 375 l/ha (125 or 250 g of glyphosate free acid/ha and 300 g of adjuvant/ha). The adjuvant Ad1 is an aqeuous solution of 200 g/l Genamin® T150 (a tallow fatty amine ethoxylate with 15 EO). The adjuvant Ad2 is Genamin® T050 (a tallow fatty amine ethoxylate with 5 EO). The results are summarized in Table 4.

Soya (glycine max) Variant Deltapine was genetically engineered to resist glyphosate. These data demonstrated that the addition of K₂CO₃ has no phytotoxity effect on plants.

TABLE 4
Activity [%] after 7 DAT (days after treatment)

| | Soya Deltapine | Soya Deltapine |
|---|---|---|
| | 125 g/ha Active | 250 g/ha Active |
| Gly-K + Ad1^{a)} | 5 | 5 |
| Gly-K + Ad1 + K₂CO₃ | 5 | 7 |
| Gly-K + Ad2^{a)} | 5 | 5 |
| Gly-K + Ad2 + K₂CO₃ | 2 | 5 |

^{a)}Comparative experiment.

### Example 9

### Volatility

The volatility was determined by analyzing the loss of material by HLPL at 70° C. after 24 h at atmospheric pressure and the loss is summarized in Table 5. The application rate was 500 g/ha dicamba (free acid), 1000 g/ha potassium glyphosate, 300 g/ha Genamin® T050 (“Ad2”, 300 g/ha Preference® (“Ad3”) and optionally 250, 500 or 1000 g/ha K₂CO₃. Deionised water (hardness<1° dH) was used to prepare the samples. Dicamba BAPMA refers to the bis(3-aminopropyl)methylamine salt of dicamba.

TABLE 5
Loss of dicamba

| | pH of tank mix | Loss (wt %) |
|---|---|---|
| Dicamba BAPMA ^{a)} | 6.3 | <1 |
| Dicamba BAPMA + Gly-K + Ad2 + Ad3 ^{a)} | 5 | 15 |
| Dicamba BAPMA + Gly-K + Ad2 + Ad3 + 250 g/ha K₂CO₃ | 6 | 6 |
| Dicamba BAPMA + Gly-K + Ad2 + Ad3 + 500 g/ha K₂CO₃ | 7 | <4 |
| Dicamba BAPMA + Gly-K + Ad2 + Ad3 + 1000 g/ha K₂CO₃ | 9 | <3 |

^{a)} Comparative experiment.

### Example 10

### Preparation of Tankmix

A tank mix is prepared (applicable at a rate of 100 l/ha) by mixing 1000 g potassium glyphosate, 0.83 l of bis(3-aminopropyl)methylamine salt of dicamba in water (600 g/l dicamba content), 300 g Preference®, and 2.0 l of the liquid tank mix adjuvant from Example 1 h) in 60 l water (hardness 10° dH), and filling up with the water to a final volume of 100 l.

1-18. (canceled)

19. A method for preparing a tank mix, which comprises contacting a glyphosate formulation, water, and a tank mix adjuvant,
wherein the tank mix adjuvant comprises a base selected from a carbonate or an alkali salt of a phosphate,
wherein the tank mix adjuvant is present in form of an aqueous liquid, which contains at least 50 g/l of the base, or in form of a particulate solid, which contains at least 10 wt % of the base,
wherein the tank mix has a tank mix acidity of at least pH 8.0,
wherein the tank mix contains at least 50 wt % water, and
wherein the glyphosate formulation contains at least 10 wt % glyphosate.

20. The method according to claim 19, wherein the base is selected from an alkali salt of carbonate, an alkali salt of hydrogencarbonate, or mixtures thereof.

21. The method according to claim 19, wherein the base is a mixture of an alkali salt of carbonate and an alkali salt of hydrogencarbonate.

22. The method according to claim 21, wherein the weight ratio of the alkali salt of a carbonate to the alkali salt of a hydrogencarbonate is in the range of 1:20 to 20:1.

23. The method according to claim 19, wherein the tank mix has a tank mix acidity of pH 8.5 to 11.0.

24. The method according to claim 19, wherein a glyphosate formulation, water, a tank mix adjuvant and a further pesticide formulation are contacted.

25. The method according to claim 19, wherein the tank mix contains from 0.4 to 200 g/1 of the base.

26. The method according to claim 19, wherein the tankmix contains at least 80 wt % water.

27. The method according to claim 19, wherein the tank mix adjuvant, which is present in form of the aqueous liquid, has a pH value in the range from 8.0 to 14.0.

28. The method according to claim 19, wherein the tank mix adjuvant, which is present in form of the particulate solid, has a particle size D₉₀ of up to 10 mm.

29. The method according to claim 19, wherein the molar ratio of the base to the pesticide is from 10:1 to 1:5.

30. The method according to claim 19, wherein the tank mix adjuvant and/or the tank mix contains a crystallization inhibitor selected from polyacrylic acids and their salts.

31. The method according to claim 19, wherein the aqueous liquid contains at least 200 g/l of the base.

32. The method according to claim 19, wherein the particulate solid contains at least 50 wt % of the base.

33. A tank mix adjuvant as defined in claim 19 which comprises an auxiliary and a base selected from a carbonate or an alkali salt of a phosphate, wherein the tank mix adjuvant is present in form of an aqueous liquid, which contains at least 50 g/l of the base, and wherein the auxiliary is a humectant.

34. The tank mix adjuvant according to claim 33, wherein the humectant is a sugar syrup.

35. The tank mix adjuvant according to claim 33 comprising at least 200 g/l of the base and 5 to 70 wt % of the humectant.

36. A method of controlling phytopathogenic fungi and/or undesired vegetation and/or undesired insect or mite attack and/or for regulating the growth of plants, wherein the tank mix as defined in claim 19 is allowed to act on the respective pests, their environment or the plants to be protected from the respective pest, on the soil and/or on undesired plants and/or the crop plants and/or their environment.
